(19) United States
(12) Patent Application Publication
(10) Pub. No.: US 2025/0357963 A1
(43) Pub. Date: Nov. 20, 2025

(54) Joint Radio Architecture to Support Receiving Streams from Multiple Sources Concurrently

(71) Applicant: Google LLC, Mountain View, CA (US)

(72) Inventors: Peter T. Liu, San Francisco, CA (US); Thomas Girardier, San Francisco, CA (US); Xuemei Ouyang, Redwood City, CA (US); Chi Kin Benjamin Leung, Sunnyvale, CA (US)

(73) Assignee: Google LLC, Mountain View, CA (US)

(21) Appl. No.: 18/866,543

(22) PCT Filed: Jun. 22, 2022
(86) PCT No.: PCT/US2022/034472

§ 371 Date: Nov. 17, 2024

(51) Int. Cl. H04B 1/525; H04B 1/3827; H04B 1/401

(52) U.S. Cl. CPC H04B 1/525; H04B 1/401; H04B 2001/3866

(57) ABSTRACT

For a transceiver including a plurality of receivers and a transmitter, controlling simultaneous reception of a first reception signal on a first one of the receivers and a second reception signal on a second one of the receivers, and controlling a timing of transmission of a transmission signal by the transmitter according to both reception at the first one of the receivers and reception at the second one of the receivers.

### BACKGROUND

Wireless listening devices are usually connected to one source at a time and thus need to be streaming audio from only one source at a time. For BLUETOOTH listening devices, such as earbuds or speakers, connections between the devices and sources typically take the form of BLUETOOTH links mapping one transmitter to one receiver. Further, even in cases where a user perceives a wireless listening device to be connected to multiple sources, the wireless listening device typically switches between the sources and streams audio data from only one source at a time. For example, when earbuds are perceived to be connected to a phone and a watch, the earbuds switch between the phone and the watch so that, at any given time, the earbuds stream audio data from only one of the phone and the watch.

### BRIEF SUMMARY

It has been recognized that there is a desire for wireless listening devices to be able to receive streams from multiple sources concurrently. In particular, audio technology having the ability to receive streams from multiple sources concurrently would allow for system notifications and voice-based assistants to be overlaid on top of music in a manner that is intelligible and non-disruptive to the user.

It has been further recognized that there are draw backs associated with attempting to enable a listening device to receive streams from multiple sources concurrently by incorporating multiple two-way radios in the listening device. For one, incorporating multiple two-way radios (i.e., multiple RX/TX radios) in an earbud or speaker results in transmissions from one of the radios interfering with reception by the other radio. For example, transmission by one earbud radio of acknowledgement (ACK) signals, or other signals, required by the BLUETOOTH protocol, desensitizes the RX stage of the other radio in the earbud, thereby likely causing the other radio to fail to receive signals (e.g., packets) intended for the other radio. Moreover, due to the small size of earbuds and portable speakers, transmission by one radio in such a device desensitizes the RX stage of another radio in the device even when the radios are provided with separate antennas.

In addition, it has been recognized that there are draw backs associated with schemes attempting to enable a listening device to receive streams from multiple sources by switching a single receiver between multiple sources in a time-division-multiplexed (TDM) manner. By way of example, BLUETOOTH and many other modern wireless schemes compress audio into wireless packets such that the packets do not occupy 100% of the available airtime of a given RF channel. This allows time for other traffic (such as Wi-Fi or LTE) and for retransmission of wireless packets that are lost to RF interference and fading. For cases where wireless packets of interest from each source occupies only a small portion of a predetermined interval, it is likely that two sources would not both be transmitting at the same time. Thus, a single receiver can listen to one source first and then switch to listen to the second source: however, there are inevitably corner cases where two different sources transmit wireless audio packets at the same time and at different RF frequencies. A single receiver, being by necessity tuned to a single frequency, is able to receive from only one source and would thus be oblivious to the transmissions from the second source. Thus, the receiver must rely on the second source retransmitting at a later time, when hopefully, the receiver is done with the first source. Similarly, when the receiver switches to the second source, it would be oblivious to transmissions from the first source, and must rely on the first source retransmitting at a later time. However, there are only a finite number of retransmissions designed into a scheme, because at the receiving device, audio packets are being played out at a constant rate, and thus there is a point in time when the wireless packet must have been successfully received and decoded or else there is no new audio packet to play, resulting in an audio dropout that is unpleasant to the listener. Moreover, these finite retransmissions were designed to overcome a predetermined level of RF interference and fading, and not a single receiver being occupied with another source. Therefore, switching leads to degraded link reliability with both sources in a high RF interference and fading environment as compared to a single source-receiver situation, and thereby leads to degraded audio quality for streams received from both sources. Still further, while source designers might attempt to incorporate additional retransmits into their protocols, these additional retransmits consume additional power and spectrum, and audio latency often needs to be increased to fit more retransmits, all of which are undesirable.

It has also been recognized that there are drawbacks associated with attempting to enable a listening device to receive streams from multiple sources concurrently by employing BLUETOOTH sniffer technology. BLUETOOTH sniffers are used to debug BLUETOOTH communications in a non-intrusive fashion. As such, BLUETOOTH sniffers have been designed to simultaneously receive BLUETOOTH packets on multiple, or all, BLUETOOTH frequency channels, even with a single antenna. However, BLUETOOTH sniffers are non-connected passive devices, and are not able to transmit packets, such as ACK packets, to the sources from which they receive.

In view of the desire to allow for reception at a device simultaneously from two distinct sources while allowing for transmission from the device, the present technology is provided.

In one aspect, the technology provides a transceiver including a plurality of receivers: a transmitter; and a controller operable to control simultaneous reception of a first reception signal on a first one of the receivers, and a second reception signal on a second one of the receivers, and to control a timing of transmission of a transmission signal by the transmitter according to both reception at the first one of the receivers and reception at the second one of the receivers.

In another aspect, the technology provides a communication method for use with a transceiver including a plurality of receivers and a transmitter, the method including controlling simultaneous reception of a first reception signal on a first one of the receivers and a second reception signal on a second one of the receivers, and controlling a timing of transmission of a transmission signal by the transmitter according to both reception at the first one of the receivers and reception at the second one of the receivers.

### BRIEF DESCRIPTION OF THE DRAWINGS

The accompanying drawings are not intended to be drawn to scale. Also, for purposes of clarity not every component may be labeled in every drawing. In the drawings:

FIG. 1 is a block diagram of a personal listening device according to an embodiment.

FIG. 2 is a diagram referred to for purposes of describing how the personal listening device of FIG. 1 may interact with two illustrative source devices.

FIG. 3 is a block diagram showing a configuration of elements in a personal listening device of an embodiment.

FIG. 4 is a flow chart depicting an illustrative flow of operations for controlling transmissions from a transceiver that is operable to perform simultaneous reception from multiple sources.

### DETAILED DESCRIPTION

Examples of systems and methods are described herein. It should be understood that the words “example,” “exemplary” and “illustrative” are used herein to mean “serving as an example, instance, or illustration.” Any embodiment or feature described herein as being an “example.” “exemplary” or “illustration” is not necessarily to be construed as preferred or advantageous over other embodiments or features. In the following description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

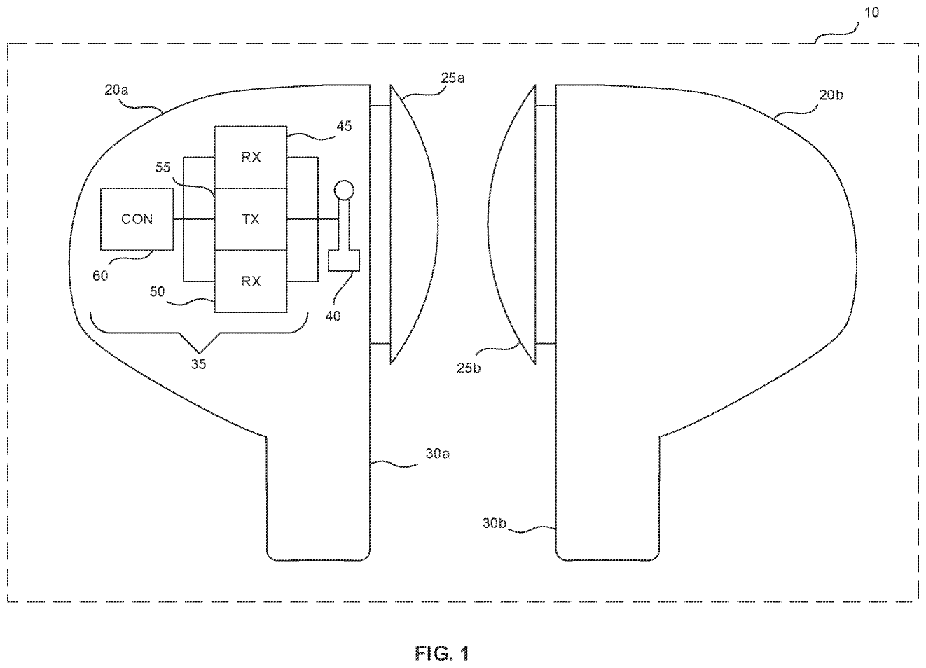

FIG. 1 is a block diagram of a personal listening device 10 according to an embodiment. The personal listening device 10 is a pair of wireless earbuds 20a and 20b, although the listening device 10 is merely illustrative of the listening devices to which the technology of this disclosure is applicable. Other listening devices in which the technology may be employed include wireless headphones, wireless earphones, and wireless speakers. Moreover, the wide range of listening devices in which the present technology may be employed will be apparent to one skilled in the art upon review of the present disclosure. In any event, for conciseness of explanation, the present description is provided largely in the context of earbuds.

As can be seen from FIG. 1, earbuds 20a and 20b include respective ear tips 25a and 25b for contacting respective ears of a user. The earbuds 20a and 20b also include respective housings 30a and 30b. Within housing 30a there is a transceiver 35 coupled to an antenna 40. As shown, the transceiver 35 may include a first receiver 45, a second receiver 50, a transmitter 55, and a controller 60, with the controller 60 coupled to the first receiver 45, the second receiver 50, and the transmitter 55. The first receiver 45 and second receiver 50 are used to receive respective reception signals either simultaneously or at different times. The transmitter 55 is used to transmit transmission signals at times when neither the first receiver 45 nor the second receiver 40 is receiving, or when one of the receivers has finished receiving and the other receiver is still receiving. The controller 60 controls operation of the first receiver 45, second receiver 50, and transmitter 60. Thus, the controller 60 is operable to control simultaneous reception of a first reception signal by the first receiver 45 and a second reception signal by the second receiver 50, and to control transmission of a transmission signal by transmitter 55, such that the transmission signal is transmitted only at a time or times when no signals are received by receivers 45 and 50, or when one of the receivers has finished receiving and the other receiver is still receiving.

In some embodiments, a transmission signal transmitted by transmitter 55 may be transmitted in response to a reception signal received at the first receiver 45 and/or in response to a reception signal received at the second receiver 50. For instance, a reception signal received at receiver 45 or at receiver 50 may be a signal conforming to a communication protocol employing acknowledgement (ACK) and negative-acknowledgement (NACK), and in such case the transmitter 55 may be used to transmit an ACK or NACK in response to the reception signal. Accordingly, the transmitter 55 may transmit a first ACK or NACK signal in response to reception at first receiver 45 of a signal from a first source, and may transmit a second ACK or NACK signal in response to reception at second receiver 50 of a signal from a second source. The sources of the signals received at the receiver 45 and/or receiver 50 will retransmit their packets upon the reception of a NACK or upon the absence of an ACK within the expected time frame. These retransmits may occur for a period of time before the source gives up and moves on to the next packet. One example of a communications protocol employing ACK and NACK signals is the BLUETOOTH protocol, and thus receiver 45, receiver 50, and transmitter 55 may be used to conduct BLUETOOTH communications between two sources and earbud 20a.

In some embodiments, earbud 20a is linked to earbud 20b. The link between earbud 20a and earbud 20b may be a wireless link or a wired link, and is provided so that earbud 20a may pass information to earbud 20b, such as audio intended for playback through earbud 20b. For example, when a stereo audio signal is received by receiver 45 and/or receiver 50 of earbud 20a, a portion of the stereo audio signal corresponding to one of the stereo channels is sent to earbud 20b. The link between earbud 20a an earbud 20b is not shown in FIG. 1.

In some embodiments, earbud 20b includes a transceiver like that of transceiver 35 and an antenna like that of antenna 40. In such embodiments, earbud 20b may receive the same signals received by receivers 45 and 50 of earbud 20a or may receive signals that are different from the signals received by receivers 45 and 50, and may transmit in response to the received signals.

In any event, it should be noted that the transceiver 35 of FIG. 1 is merely illustrative. Transceivers of the presently disclosed technology are not restricted to two receivers and one transmitter. A transceiver in accordance with the present technology may include more than two receivers and one transmitter, two receivers and more than one transmitter, or more than two receivers and more than one transmitter. However, regardless of the number of receivers and transmitters in the transceiver, the transceiver is operable to simultaneously receive signals on multiple of its receivers, or all of its receivers, while transmitting on one or more of its transmitters, in some embodiments with transmissions occurring only at a time or times when no signals are received by the receivers.

It should be further noted that the antenna 40 of FIG. 1 is merely illustrative. A listening device according to the present technology may include more than one antenna. For example, earbud 20a of FIG. 1 may include two or more antennas. Also, the antenna 40 may be an integral or distinct component of transceiver 35. In some embodiments, each of receiver 45, receiver 50, and transmitter 55 is provided with an antenna, and such antennas are integral with transceiver 35.

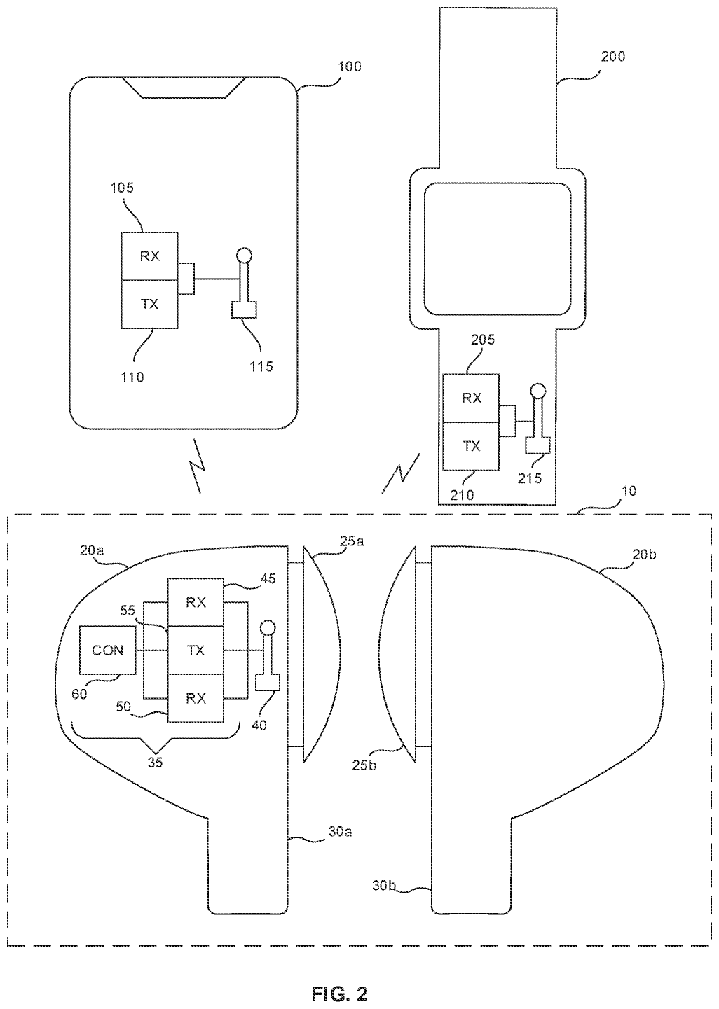

Turning now to FIG. 2, the figure will be referenced for purposes of describing how the personal listening device 10 of FIG. 1 may interact with two illustrative source devices. As can be seen from FIG. 2, listening device 10 may communicate with a mobile phone 100 as a first source device, and a watch (or “smartwatch”) 200 as a second source device. The phone 100 may include a receiver 105 and a transmitter 110, both coupled to an antenna 115. The watch 200 may, similarly, include a receiver 205 and a transmitter 210, both coupled to an antenna 215. By way of example, the phone 100 may use transmitter 110 to transmit music to receiver 45 of earbud 20a via BLUETOOTH, and watch 200 may use transmitter 210 to transmit exercise instructions to receiver 50 of earbud 20a via BLUETOOTH. In this manner, a user of earbuds 20a and 20b may exercise to music while wearing the earbuds 20a and 20b while still being able to receive exercise instructions from watch 200, which may include, for example, a pulse rate monitor. Since receivers 45 and 50 of earbud 20a may receive transmissions from transmitter 110 and transmitter 210 at the same time, the user can experience the music uninterrupted with the exercise instructions being timely presented to the user as a voice-over. Also, the ACK and NACK signals necessary for the BLUETOOTH communications between the phone 100 and device 10 and between the watch 200 and device 10 may be respectively provided by transmitter 55 of earbud 20a to receiver 105 of phone 100 and to receiver 205 of watch 200. Notably, transmitter 55 does not transmit when either of receivers 45 or 50 is receiving, so that the transmission of the ACK and NACK signals to phone 100 and watch 200 does not desensitize receivers 45 and 50 to signals from phone 100 and watch 200. However, if the controller 60 decides that the ACK corresponding to a packet received from the watch 200 must be sent to meet certain timing constraints, it may choose to do so at the expense of a packet that is currently being received from the phone 100.

FIG. 2 depicts only phone 100 as a first source and watch 200 as a second source. However, it should be noted that embodiments include those in which (1) phone 100 is part of a piconet and watch 200 is not part of a piconet, (2) phone 100 is not part of a piconet and watch 200 is part of a piconet, and (3) phone 100 is part of a first piconet and watch 200 is part of a second piconet. More generally, for any first source and second source respectively transmitting to receivers 45 and 50 of earbud 20a, embodiments include those in which (1) the first source is part of a piconet and the second source is not part of a piconet. (2) the first source is not part of a piconet and the second source is part of a piconet, and (3) the first source is part of a first piconet and the second source is part of a second piconet.

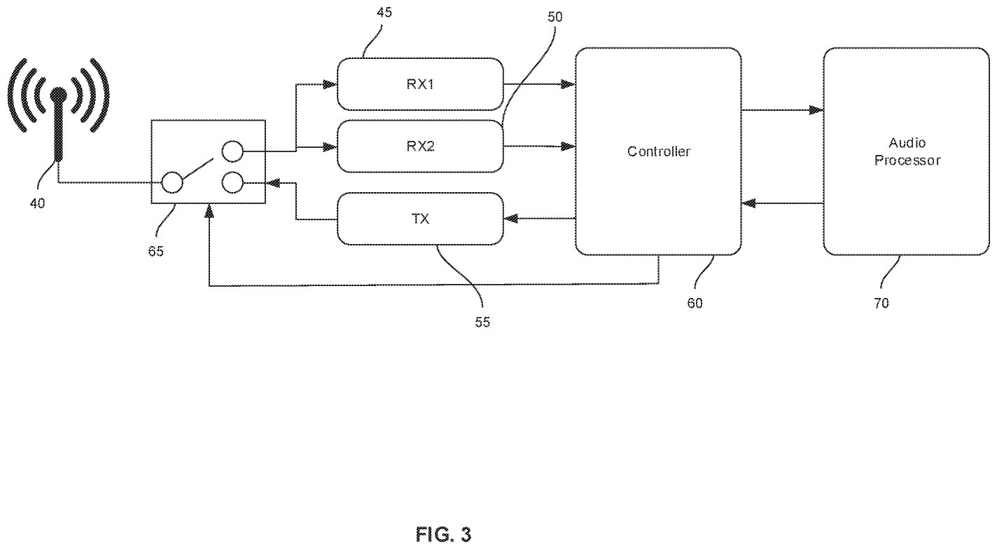

As noted, some embodiments of the present technology include one antenna, two RX blocks (receivers), and one TX block (transmitter), all coordinated by a single link controller in an earbud or speaker. The antenna is switched by the controller in time-multiplexed fashion between the RF inputs of the two RX blocks—connected together—and the RF output of the TX block. An example is shown in FIG. 3, which depicts a configuration in which switching of the antenna 40 between the RF inputs of receivers 45 and 50—connected together—and the RF output of transmitter 55 is controlled by controller 60 through a single pole double throw switch 65, the signals received by receivers 45 and 50 are relayed from the controller 60 to an audio processor 70 for processing (e.g., for determining whether to send an ACK in response to a received signal), and the signals transmitted by transmitter 55 (e.g., ACK signals) are passed to the controller 60 from the audio processor 70. Each RX block is tuned and hopping in synchronization to, for example, a piconet established with one audio source's BLUETOOTH radio. Each RX block thus has a full opportunity designed into the air channel's protocol to receive signals from an associated source TX, even when multiple sources overlap each other in time—an advantage over single radios in earbuds which must “time-share” RX, e.g., between two piconets. In cases where multiple sources overlap each other in both frequency and time, that is a collision and is handled in the same manner as a collision between two single TX/RX systems (i.e., two systems that each have a single TX communicating with a single RX), such that the multi-stream system of the present disclosure performs no worse with respect to collisions than a single-stream system. For example, two BLUETOOTH signals intended for reception at respective receivers 45 and 50 of a transceiver 35 are said to collide when they are transmitted on the same BLUETOOTH channel and arrive at the transceiver 35 at the same time. If such a collision occurs, the colliding signals will be errored and the recipients of the colliding signals will send back either a NACK to one of the senders or not acknowledge either of the senders. For each sender, when the sender does not receive an ACK response, the sender will later resend the same data payload signal at a different frequency and time (BLUETOOTH hops every subinterval) as long as scheduling and other constraints permit.

Thus, in the FIG. 2 scenario for instance, when a transmission from the phone 100 to receiver 45 overlaps in frequency and time with a transmission from watch 200 to receiver 50, only one of the transmissions will be received and acknowledged, and the other transmission may be repeated at a later time. Other embodiments of the present technology include one antenna for each RX block.

In any event, TX signals from a listening device of the present technology may be scheduled such that they are transmitted at a time that all RXs of the listening device are not receiving. For example, in a packet-based system according to the present technology, TX packets from the listening device may be scheduled such that they are transmitted at a time that all RXs of the listening device are done receiving packets. These TX packets may be transmitted over the air by one TX block or by multiple TX blocks at different frequencies, either simultaneously or in a time-interleaved fashion. Thus, the listening device avoids desensitizing any of the RX blocks—an advantage over schemes which employ two independent radios inside a listening device.

Moreover, while scheduling TX signals in a listening device according to the present technology can result in the window for sending an ACK to a source to be missed, the result of such a miss is inconsequential. The source either retransmits the data packet for which the ACK was missed, or does not retransmit the data packet for which the ACK was missed and marks the data packet as dropped, because a missing ACK shows as a NACK to the source. In either case, the listening device received the data and proceeded to render it to the user. In addition, missing the window for sending an ACK is further mitigated by the fact that in most of the cases of simultaneous packet receptions, only one packet will require an ACK. For example, if multiple streams are received from multiple connected links, the sink can attempt to make the connections not overlap most of the time, typically by requesting one of the sources to offset its transmission schedule. In other cases, there might be only a single connected link and multiple broadcast links, so only a single ACK is required.

Nevertheless, it should be noted that at times it may be desirable to sacrifice RX packets from one source to meet critical timing requirements of the other source. Such sacrificing may entail sending back an ACK to the higher priority source while the lower priority source's RX packet is underway, thereby corrupting the RX packet. The corrupted RX packet would need to be resent by the other source.

Incidentally, the present technology still allows for time-division-multiplexing of any one of its RX blocks between multiple sources. For example, while receivers 45 and 50 may be used to receive from respective sources at the same time, either one or both of receivers 45 and 50 may receive from multiple sources on a time-division-multiplexing basis.

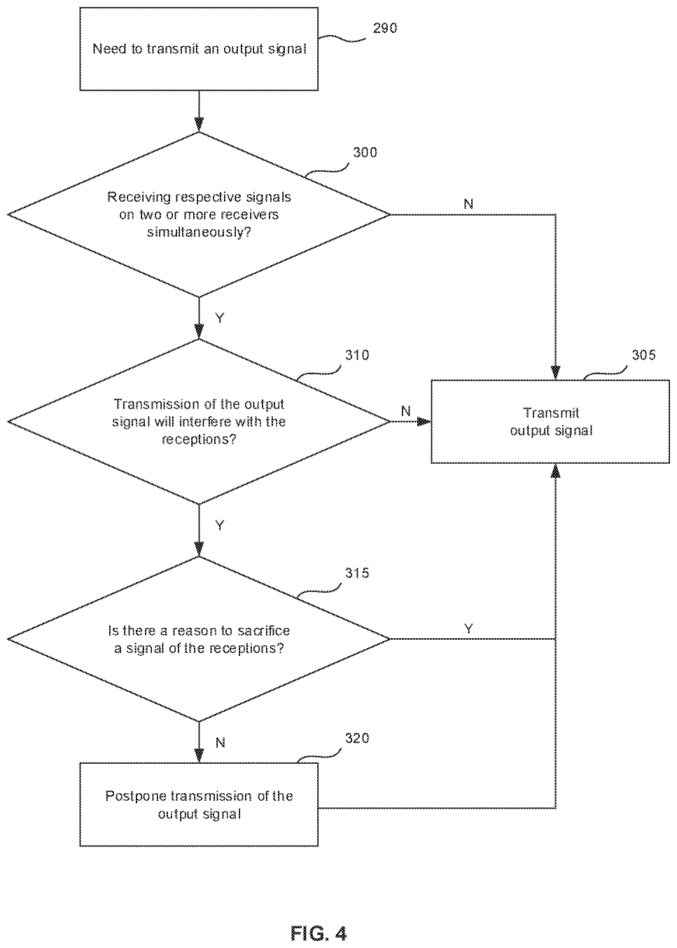

Referring now to FIG. 4, the figure is a flow chart depicting an example flow of operations according to an embodiment for controlling transmissions from a transceiver that has multiple receivers and is operable to receive respective signals on two or more of the multiple receivers at the same time. The operations depicted in FIG. 4 may be performed by listening device 10 of FIGS. 1 and 2. As can be seen from FIG. 4, the operations begin with an indication that the transceiver (e.g., transceiver 35) needs to transmit an output signal in response to a received signal (step 290). Next a determination is made as to whether the transceiver is receiving respective signals on two or more of the multiple receivers (e.g., receivers 45 and 50) simultaneously (step 300). If the transceiver is not receiving respective signals on two or more of the multiple receivers simultaneously, reception on any one receiver, and transmissions by the transceiver in response to such reception, may be handled according to conventional procedures and the transceiver may transmit the output signal (step 305). However, if the transceiver is receiving respective signals on two or more of the multiple receivers simultaneously, a determination is made as to whether any transmission by the transceiver in response to the multiple receptions will interfere with any reception by any of the receivers within the transceiver (step 310). If any transmission by the transceiver in response to the multiple receptions will not interfere with any reception by the transceiver, then transmission by the transceiver may be handled according to conventional procedures and the transceiver may transmit the output signal (step 305). However, if any transmissions by the transceiver will interfere with any of the multiple receptions, then a determination is made as to whether there is a reason to sacrifice one of the signals of the multiple receptions (e.g., a packet whose reception is still underway) (step 315) If there is a reason to sacrifice one of the signals of the multiple receptions, then the transceiver may transmit the output signal (step 305), with the understanding that such transmission will likely interfere with one or more of the multiple receptions and result in the likely sacrifice of one or more signals of the multiple receptions. However, if there is no reason to sacrifice one of the signals of the multiple receptions, then transmission of the output signal is postponed so as to avoid interference with any of the multiple receptions (step 320). After the postponement, the transceiver may transmit the output signal according to any scheduling constraints (step 305).

It should be noted, that in an alternative embodiment a listening device may include all of the elements of transceiver 35 along with one or more receive antennas and one or more transmit antennas. In such embodiment, if transmission by the one or more transmit antennas does not degrade reception on any of the one or more receive antennas, the operations of FIG. 4 are not necessary.

Having described the present technology in the context of FIGS. 1-4, the technology will now be described in the context of example signal timings, with reference to signal timeline charts.

The following Chart 1 depicts air packet timing for an earbud with a single receiver and single transmitter.

As can be seen from Chart 1, the earbud is in a piconet with a phone (e.g., phone 100) and is in a separate piconet with a watch (e.g., watch 200). Each piconet has its own clock and is not locked to the other piconet. P1 is payload #1 from the phone and P2 is payload #2 from the phone, W1 is payload #1 from the watch and W2 is payload #2 from the watch, T1 is the first transmission of a payload, T2 is the 2nd transmission (i.e., a retransmission). The time between P1 and P2 is defined as the isoch interval of the phone and stays fixed for all subsequent payloads from the phone for the duration of the stream. The time between W1 and W2 is defined as the isoch interval of the watch and stays fixed for all subsequent payloads from the watch for the duration of the stream. For each payload that is sent, the source expects to get back an ACK from the sink. The time interval of a payload and its ACK is defined as a subevent. Within an isoch interval, there can be multiple subevents. If in a first subevent a source receives an ACK, then the source does not retransmit on a future subevent. If a source does not receive an ACK on a first subevent, then the source retransmits on a future subevent, which may be within the same isoch interval as the first subevent or may be in a future isoch interval.

For simplicity, assume that each source is configured to do one retransmission of audio data payload in the immediately following subevent for which a first payload was lost (i.e., no ACK was received back from earbud). The earbud first receives P1T1 from the phone. Shortly thereafter, the watch starts sending W1T1 to the earbud. However, because the earbud's sole receiver is tuned to the phone's piconet, the earbud is unaware that the watch is transmitting. The earbud finishes receiving P1T1 successfully and sends an ACK to the phone. In the meantime, the watch did not get back an ACK for W1T1 and so it prepares to send W1T2 (a retransmission of W1) on the next subevent. The earbud's controller now switches its receiver to the watch's piconet and W1T2 is successfully received and acknowledged. The pattern repeats itself for subsequent payloads from phone and watch.

The first shortcoming is that W1 is received later than P1. This reduces the time for processing W1 vs. P1 in the earbud. The second shortcoming is that link reliability with both sources is significantly degraded. For example, consider Chart 2 below.

As illustrated in Chart 2, the earbud receives P1T1 with errors and sends back a NACK so that the phone would know to retransmit. While the earbud was receiving P1T1, it had to ignore W1T1. Subsequently, while the ear bud was receiving P1T2, it could not receive W1T2. Afterwards, since there are no more retransmits of W1, W1 is never received, resulting in a missing audio sample for stream W. Therefore, an errored receive on the stream from the phone resulted in a completely dropped audio sample from the watch.

Suppose now that P2T1 is received successfully and the earbud switches to receive W2T2. However, suppose that due to random interference, W2T2 was received with errors, and since there are no more retransmits, W2 is never received, resulting in a missing audio sample for the audio stream from the watch. In this simplified example, had the earbud been able to receive W2T1, then it would have doubled its probability of success.

The presently disclosed technology addresses the above shortcomings by adding a second RX block in the earbud (e.g., by providing earbud 20a). The advantages of adding a second RX block are discussed in connection with Chart 3 below.

RX1 is in the phone's piconet, RX2 is in the watch's piconet, and the TX switches between piconets. P1T1 is received by RX1, and even though W1T1 overlaps with P1T1, W1T1 is received by RX2. However, the earbud's controller (e.g., controller 60) withholds sending the ACK for P1T1 because RX2 is still actively receiving. The controller therefore schedules P1T1's ACK for the next subevent associated with P1 traffic, namely P1T2. But before then, the earbud has the opportunity to acknowledge W1T1, without disrupting anything else and so it does so.

Thus, P1 and W1 are both received on the first transmission attempt, and the earbud can proceed to decode and render them with full time available. The only side-effect is that the phone always has to transmit its payload an extra time P1T2, P2T2, etc. but the phone has a larger battery than the earbud and can afford to do so. If W1T1 arrived at the same time as P1T1, the above analysis still holds. The earbud's controller would choose whether to acknowledge the phone first or the watch first. If one source is configured to have fewer repeat transmissions, then the earbud's controller can choose to acknowledge this source first. The controller can also switch the priority of acknowledgment on a per isoch interval basis, if for example, there are fewer retransmit subevents available for one source due to normal link errors.

Isoch interval 2 in Chart 3 is used to illustrate what happens when there is an errored reception. Suppose during the 1st attempt, an error is encountered in each of W2T1 and P2T1. The NACKs associated with each are postponed because sending them would corrupt the (potential) reception of W2T2 and P2T2. Since a NACK (or an ACK) that is never received by a sender is treated as a NACK, both watch and phone will resend W2 and P2. The earbud has to postpone the ACK to Phone to avoid corrupting W2T2: however, because in this example, there are no more subevents remaining on the phone's piconet, this ACK is never sent. (Had the phone received an ACK or a NACK, it would not have made a difference in this example because there would have been no slots left for resends.) The phone marks P2 as lost and moves on to send P3. The earbud did get P2 and played it out and moves on to receive P3. The earbud has an opportunity to send back an ACK to Watch and does so. In contrast to the scenario depicted in Chart 2, both W2 and P2 were received successfully by the earbud. The isoch timing could be designed for resends to occur in subsequent isoch intervals (adding latency to increase robustness), and the invention would benefit equally from such.

Embodiments of the present technology include, but are not restricted to, the following.

(1) A transceiver including a plurality of receivers: a transmitter; and a controller operable to control simultaneous reception of a first reception signal on a first one of the receivers, and a second reception signal on a second one of the receivers, and to control a timing of transmission of a transmission signal by the transmitter according to both reception at the first one of the receivers and reception at the second one of the receivers.

(2) The transceiver according to (1), wherein the transmission signal is transmitted only at a time or times when no signals are received by the receivers.

(3) The transceiver according to (1), wherein the transceiver is housed in a personal listening device.

(4) The transceiver according to (3), wherein the personal listening device is an earbud.

(5) The transceiver according to (1), wherein the transmission signal is responsive to at least one of the first reception signal or the second reception signal.

(6) The transceiver according to (5), wherein the transmission signal is responsive to the first reception signal and the second reception signal.

(7) The transceiver according to (1), wherein the first reception signal is transmitted by a first source, the second reception signal is transmitted by a second source, and the transmission signal is for communication with the first source and the second source.

(8) The transceiver according to (7), wherein the first source is a BLUETOOTH source.

(9) The transceiver according to (7), wherein the transceiver is housed in a personal listening device, the first source is a mobile phone, the second source is a watch.

(10) The transceiver according to (1), wherein the first reception signal, the second reception signal, and the transmission signal are BLUETOOTH signals.

(11) The transceiver according to (1), further comprising an antenna.

(12) A communication method for use with a transceiver including a plurality of receivers and a transmitter, the method including controlling simultaneous reception of a first reception signal on a first one of the receivers and a second reception signal on a second one of the receivers, and controlling a timing of transmission of a transmission signal by the transmitter according to both reception at the first one of the receivers and reception at the second one of the receivers.

(13) The method according to (12), wherein the transmission signal is transmitted only at a time or times when no signals are received by the receivers.

(14) The method according to (12), wherein the transceiver is housed in a personal listening device.

(15) The method according to (12), wherein the first reception signal is transmitted by a first source, the second reception signal is transmitted by a second source, and the transmission signal is for communication with the first source and the second source.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims.

1. A transceiver comprising:
a plurality of receivers;
a transmitter; and
a controller operable to control:
simultaneous reception of a first reception signal on a first one of the receivers and a second reception signal on a second one of the receivers; and
a timing of transmission of a transmission signal by the transmitter according to both reception at the first one of the receivers and reception at the second one of the receivers.

2. The transceiver according to claim 1, wherein the transmission signal is transmitted only at a time or times when no signals are received by the receivers.

3. The transceiver according to claim 1, wherein the transceiver is housed in a personal listening device.

4. The transceiver according to claim 3, wherein the personal listening device is an earbud.

5. The transceiver according to claim 1, wherein the transmission signal is responsive to at least one of the first reception signal or the second reception signal.

6. The transceiver according to claim 5, wherein the transmission signal is responsive to the first reception signal and the second reception signal.

7. The transceiver according to claim 1, wherein:
the first reception signal is transmitted by a first source;
the second reception signal is transmitted by a second source; and
the transmission signal is for communication with the first source and the second source.

8. The transceiver according to claim 7, wherein the first source is a BLUETOOTH source.

9. The transceiver according to claim 7, wherein:
the transceiver is housed in a personal listening device;
the first source is a mobile phone; and
the second source is a watch.

10. The transceiver according to claim 1, wherein the first reception signal, the second reception signal, and the transmission signal are BLUETOOTH signals.

11. The transceiver according to claim 1, further comprising an antenna.

12. A communication method for use with a transceiver comprising a plurality of receivers and a transmitter, the method comprising:
controlling simultaneous reception of a first reception signal on a first one of the receivers and a second reception signal on a second one of the receivers; and
controlling a timing of transmission of a transmission signal by the transmitter according to both reception at the first one of the receivers and reception at the second one of the receivers.

13. The method according to claim 12, wherein the transmission signal is transmitted only at a time or times when no signals are received by the receivers.

14. The method according to claim 12, wherein the transceiver is housed in a personal listening device.

15. The method according to claim 12, wherein:
the first reception signal is transmitted by a first source;
the second reception signal is transmitted by a second source; and
the transmission signal is for communication with the first source and the second source.

16. The method according to claim 12, wherein the transmission signal is responsive to at least one of the first reception signal or the second reception signal.

17. The method according to claim 12, wherein the first reception signal, the second reception signal, and the transmission signal are BLUETOOTH signals.

18. The method according to claim 12, wherein:
the first reception signal is transmitted by a first source;
the second reception signal is transmitted by a second source; and
the transmission signal is for communication with the first source and the second source.

19. The method according to claim 18, wherein the first source is a BLUETOOTH source.

20. The method according to claim 18, wherein:
the transceiver is housed in a personal listening device;
the first source is a mobile phone; and
the second source is a watch.
